(19) United States
(12) Patent Application Publication
(10) Pub. No.: US 2019/0320615 A1
(43) Pub. Date: Oct. 24, 2019

(54) PET WATER FEEDER OUTLET PIPE WITH WATER STOP STRUCTURE

(71) Applicant: HUNG I METAL CO., LTD., Changhua City (TW)

(72) Inventor: Chen-Hui CHENG, Changhua City (TW)

(21) Appl. No.: 15/957,418

(22) Filed: Apr. 19, 2018

(51) Int. Cl. A01K 7/06

(52) U.S. Cl. CPC A01K 7/06

(57) ABSTRACT

A pet water feeder outlet pipe with a water stop structure which includes an outlet pipe located at the bottom of a pet water feeder, a guiding torus and a concave ring groove. The guiding torus and concave ring groove are located in the inner wall of the outlet pipe respectively, and the concave ring groove is located between the outlet pipe orifice and the guiding torus. A ball is movably held in the outlet pipe, and partially projects from the orifice of the outlet pipe. A water stop washer is located in the concave ring groove, and the inner edge projects from the concave ring groove inwards. An inner ring flange is provided on the inner edge of the water stop washer, and the ball optionally clings to the water stop washer and the inner ring flange, so as to seal the outlet pipe for water stoppage.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a pet water feeder outlet pipe, and more particularly to the innovative structure type of a pet water feeder outlet pipe with a water stop structure.

### 2. Description of Related Art Including Information Disclosed Under 37 CFR 1.97 and 37 CFR 1.98

In terms of the water-out structure of the conventional pet water feeder outlet pipe, the vessel bottom extends obliquely towards one side to form an outlet pipe, the bottom of the outlet pipe is screwed to an end pipe, an O-ring is fixed in the end pipe, and a ball is held inside the O-ring. The outside diameter of the ball clings to the inner edge of O-ring normally to implement the water stop state. When the pet licks the ball to move up obliquely inside, the ball disengages the contact with O-ring, forming a gap, so that the internal water is delivered for the pet to drink.

The conventional pet water feeder structure type has the following problems in practical experience. As the O-ring and ball are conventional structure type, and the thickness of the O-ring is not smaller than the radius of the ball, when they contact each other normally, the outer circumference of ball clings to the inner edge of O-ring excessively, the contact area and friction between them can be increased greatly, but the moving smoothness of ball is reduced, the ball is difficult to be moved by licking, so that the water is difficult to flow out. In addition, the O-ring only clings to the inner wall of end pipe, there is no firm positioning. When the pet's tongue licks the ball, the steel ball shifts up obliquely, rubbing the O-ring, and when the pet's tongue protrudes into the outlet pipe, it is likely to push the O-ring to offset up obliquely, the water stop effect is lost, and the drinking water is likely to leak.

### BRIEF SUMMARY OF THE INVENTION

The fundamental purpose of the present invention is to provide a pet water feeder outlet pipe with a water stop structure. The technical problem to be solved is to break through how to develop a new type of pet water feeder outlet pipe with water stop structure type with more ideal practicability.

In terms of the technical characteristics of problem solving of the present invention, said pet water feeder outlet pipe with water stop structure comprises an outlet pipe, located at the bottom of a pet water feeder, a guiding torus and a concave ring groove, the guiding torus and concave ring groove are located in the inner wall of the outlet pipe respectively, and the concave ring groove is located between the outlet pipe orifice and the guiding torus; a ball movably held in the outlet pipe, and the ball can partially project from the orifice of the outlet pipe; a water stop washer located in the concave ring groove, the inner edge of the water stop washer shall project from the concave ring groove inwards; and an inner ring flange located in the inner edge of the water stop washer, and the ball optionally clings to the water stop washer and the inner ring flange, so as to seal the outlet pipe for water stoppage.

Based on the innovative design, in comparison to previous technology, the present invention can use said inner ring flange to reduce the contact area between ball and water stop washer, so as to avoid the ball being clamped effectively, enhancing the mobility and licking flexibility of ball, and the leak resistance is enhanced greatly. In addition, the water stop washer is located in the concave ring groove with firm positioning effect, and the outer edge of the water stop washer is provided with an outer ring flange, so as to fill up the gap between the water stop washer and the concave ring groove for sealing. Therefore, the defect in conventional structure that the O-ring is likely to offset upwards to lose water stop effect can be remedied. To sum up, it has practical progressiveness.

### BRIEF DESCRIPTION OF THE SEVERAL VIEWS OF THE DRAWINGS

FIG. 1 is an exploded view of the first embodiment of the present invention.

FIG. 2 is an exploded view of the outlet pipe, ball and water stop washer of the present invention.

FIG. 3 is a sectional view of the outlet pipe in water stop state of the present invention.

FIG. 4 is a close-up view of FIG. 3.

FIG. 5 shows the actuation of FIG. 3.

FIG. 6 is a broken-out section view of the second embodiment of the present invention.

FIG. 7 is a close-up view of FIG. 6.

### DETAILED DESCRIPTION OF THE INVENTION

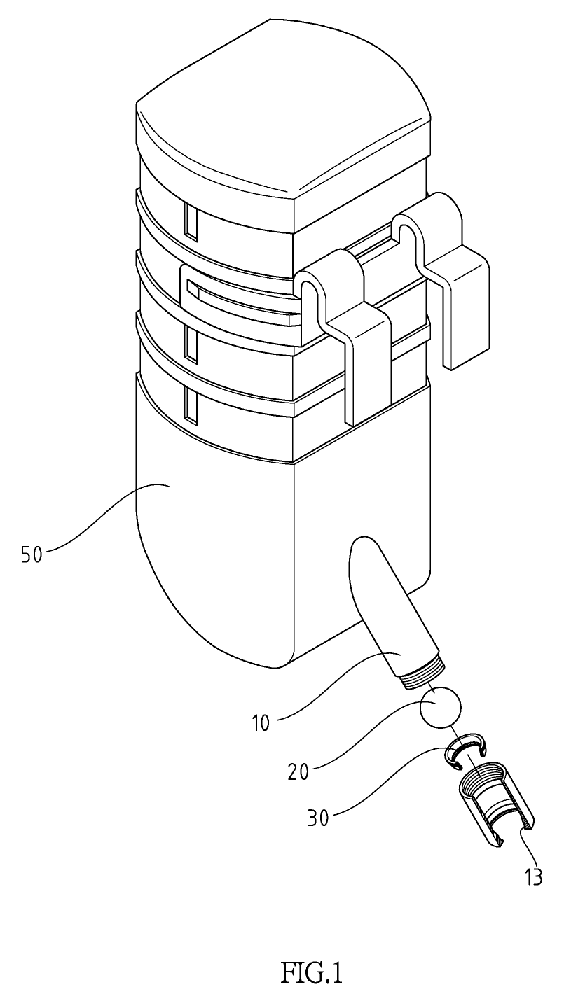

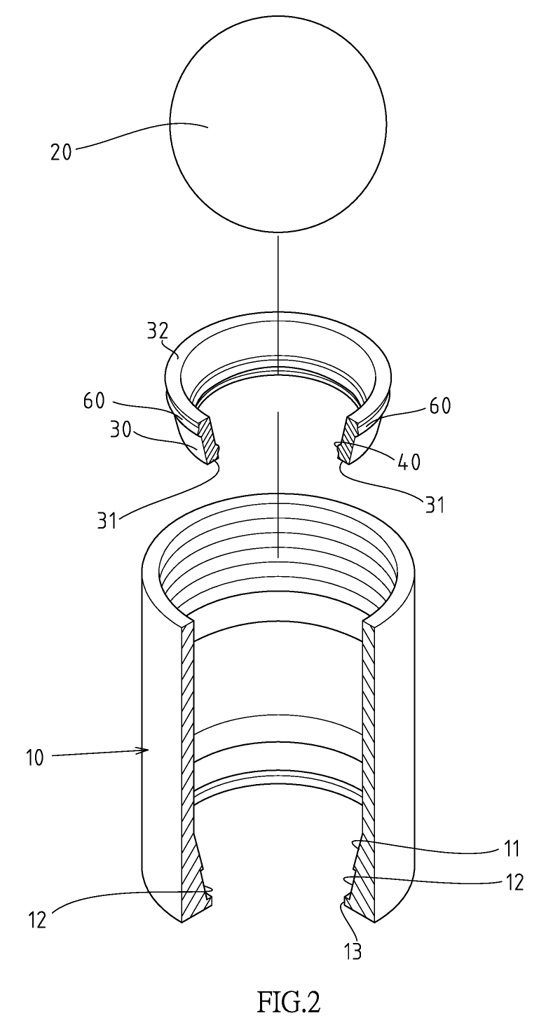

FIGS. 1 to 5 show the first embodiment of the pet water feeder outlet pipe with water stop structure of the present invention, but the embodiment is for illustration only, the patent application is not limited to this structure. Said pet water feeder outlet pipe with water stop structure comprises an outlet pipe 10, a ball 20, a water stop washer 30, an inner ring flange 40 and an outer ring flange 60. Said outlet pipe 10 is located at the bottom of a pet water feeder 50, and the outlet pipe 10 comprises a guiding torus 11 and a concave ring groove 12. The guiding torus 11 is formed on the inner wall near the orifice 13 of the outlet pipe 10, in tapered structure. the concave ring groove 12 is located in the inner wall of the outlet pipe 10, between the orifice 13 of the outlet pipe 10 and the guiding torus 11.

Said ball 20 can be movably held in the outlet pipe 10, and the ball 20 can partially project from the orifice 13 of the outlet pipe 10.

Said water stop washer 30 is located in the concave ring groove 12, the inner edge of the water stop washer 30 shall project from the concave ring groove 12 inwards, and the projection shall be enough to withstand the ball 20. Wherein the water stop washer 30 has a first end 31 and a second end 32, and the distance between the first end 31 and the second end 32 of the water stop washer 30 is smaller than the radius of the ball 20. In addition, the diameter of the water stop washer 30 is smaller than the diameter of the ball 20.

Said inner ring flange 40 is located at the inner edge of the water stop washer 30 and close to the first end 31. The ball 20 optionally clings to the water stop washer 30 and the inner ring flange 40, meanwhile the inner ring flange 40 distortedly clings to the outer circumference of the ball 20 to form tight fit, so as to seal the outlet pipe 10 for water stoppage.

Said outer ring flange 60 is located at the outer edge of the water stop washer 30 near the second end 32. The outer ring flange 60 is distortedly fixed in the concave ring groove 12, so that the gap between the water stop washer 30 and the concave ring groove 12 is closed, the defect in conventional structure that the O-ring is likely to offset upwards to lose water stop effect can be remedied.

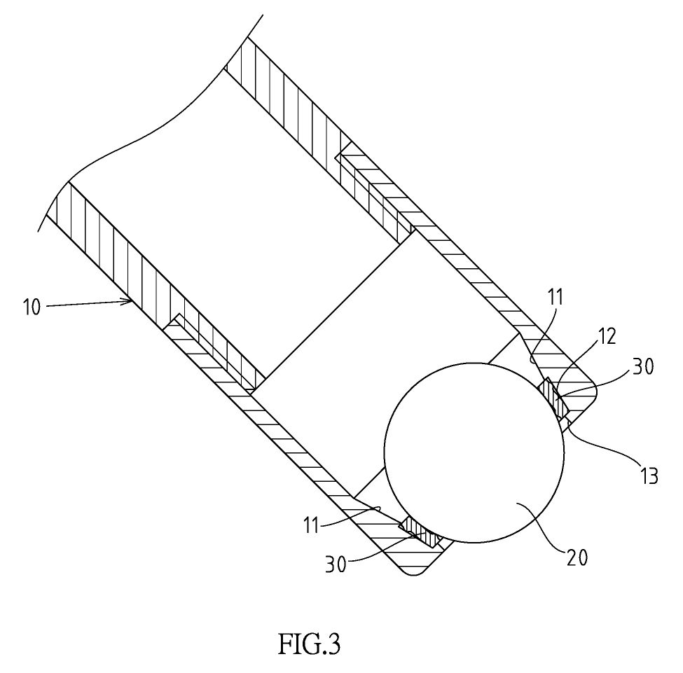

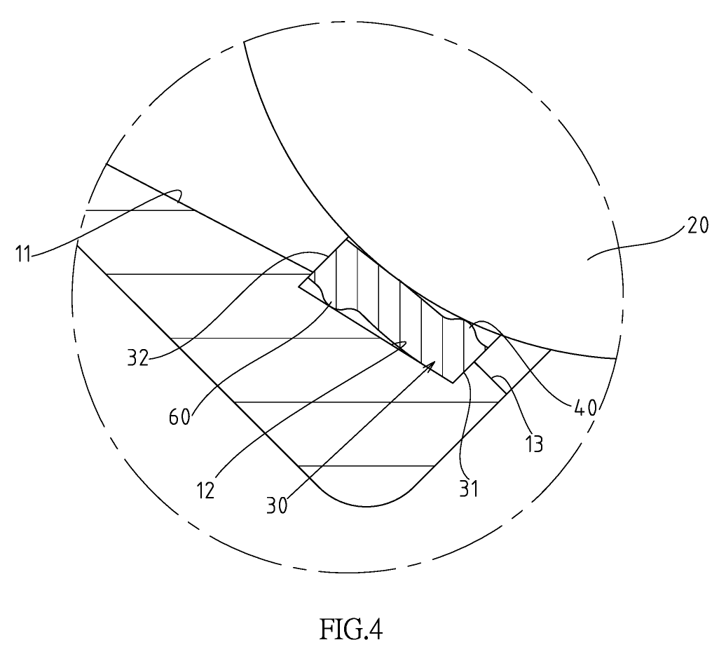

Based on said structural composition design, the actuation of the present invention is described below. First, as shown in FIGS. 3 and 4, various components of the present invention are in normal positions, due to the structure design that the distance between the first end 31 and the second end 32 of the water stop washer 30 is much smaller than the radius of the ball 20, and the inner ring flange 40 is fixed to the water stop washer 30, said inner ring flange 40 reduces the contact area between ball 20 and water stop washer 30, the ball 20 is prevented from being clamped effectively, the mobility and licking flexibility of ball 20 are enhanced, and the leak resistance is enhanced greatly.

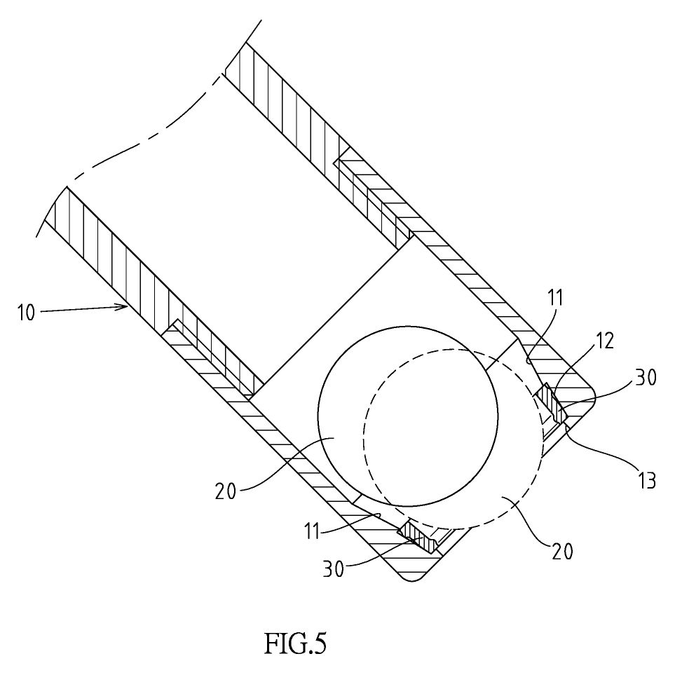

As shown in FIG. 5, when the pet drinks water, its tongue licks the ball 20 to move into outlet pipe 10, a space is formed between ball 20 and water stop washer 30, so that the water pipe 10 discharges water for the pet to drink.

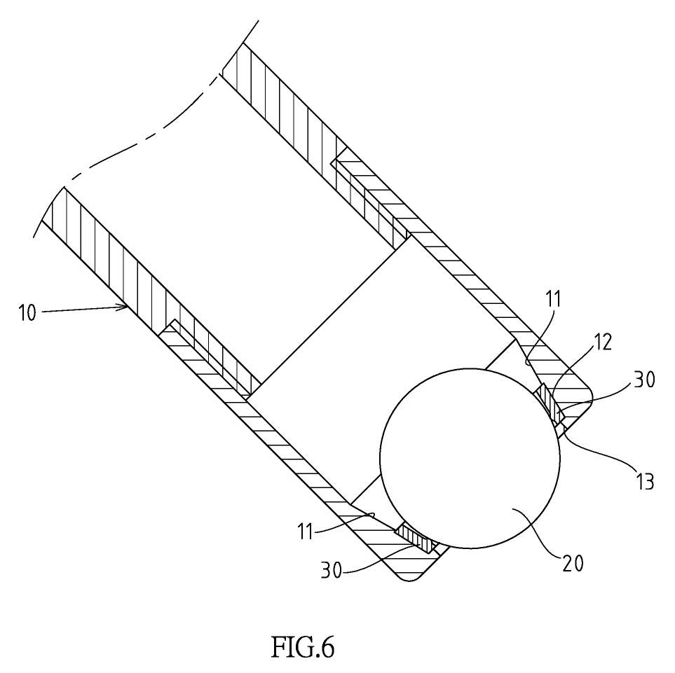

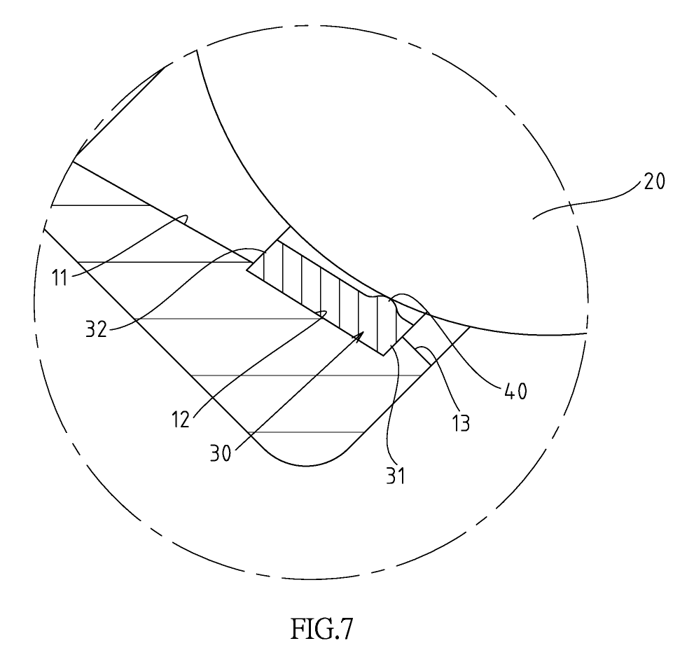

FIGS. 6 and 7 show the second embodiment of the present invention, the main difference to the first embodiment is that the outer edge of the water stop washer 30 is not provided with outer ring flange 60.

I claim:

1. A pet water feeder outlet pipe with water stop structure comprising:
an outlet pipe located at the bottom of a pet water feeder, and the outlet pipe comprises a guiding torus and a concave ring groove; the guiding torus is formed on the inner wall near the orifice of the outlet pipe, in tapered structure; the concave ring groove is located in the inner wall of the outlet pipe, and between the outlet pipe orifice and the guiding torus;
a ball movably held in the outlet pipe, and the ball can partially project from the orifice of the outlet pipe;
a water stop washer located in the concave ring groove, the inner edge of the water stop washer shall project from the concave ring groove inwards, and the projection shall be enough to withstand the ball; wherein the water stop washer has a first end and a second end; and
an inner ring flange located at the inner edge of the water stop washer and close to the first end; the ball optionally clings to the water stop washer and the inner ring flange, and the inner ring flange distortedly clings to the outer circumference of the ball to form tight fit, so as to seal the outlet pipe for water stop.

2. The pet water feeder outlet pipe with water stop structure defined in claim 1, wherein there is an outer ring flange on the outer edge of the water stop washer near the second end. The outer ring flange is distortedly fixed in the concave ring groove, sealing the gap between the water stop washer and the concave ring groove.

3. The pet water feeder outlet pipe with water stop structure device defined in claim 1, wherein the diameter of the water stop washer is smaller than the diameter of the ball.

4. The pet water feeder outlet pipe with water stop structure defined in claim 3, wherein the distance between the first end and the second end of the water stop washer is smaller than the radius of the ball.

5. The pet water feeder outlet pipe with water stop structure e defined in claim 2, wherein the diameter of the water stop washer is smaller than the diameter of the ball.

6. The pet water feeder outlet pipe with water stop structure defined in claim 5, wherein the distance between the first end and the second end of the water stop washer is smaller than the radius of the ball.
